(19) United States
(12) Patent Application Publication
(10) Pub. No.: US 2021/0304331 A1
(43) Pub. Date: Sep. 30, 2021

(54) SECURE ENCRYPTED BLOCKCHAIN FOR THE RESOURCE AND REAL ESTATE INDUSTRIES

(71) Applicant: Timothy James Costello, Tampa, FL (US)

(72) Inventor: Timothy James Costello, Tampa, FL (US)

(21) Appl. No.: 17/214,826

(22) Filed: Mar. 27, 2021

Related U.S. Application Data
(63) Continuation-in-part of application No. 63/001,431, filed on Mar. 29, 2020.

(51) Int. Cl. G06Q 50/16; G06F 16/23

(52) U.S. Cl. CPC G06Q 50/16; G06F 16/2315

(57) ABSTRACT

The present invention is a blockchain application for the real estate industry where in a first step, the transaction is submitted to the peers by an Orderer, a second step where the peers run with the local copy of the ledger, a third step where the read-write set result is returned to all the peers, a fourth step where the endorsement responses are packed into an invocation request, a fifth step where said invocation request is sent to the Order, a sixth step where the read-write set is compared with the same of all the peers, a seventh step where the transaction is added to the ledger, and an eighth step where the peers' local copy of the ledger is updated.

### CROSS REFERENCE TO RELATED APPLICATION

This application claims priority to U.S. Provisional Patent Application 63/001,431, filed on Mar. 29, 2020.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present invention relates to the field and applications of blockchain technology.

### BACKGROUND OF THE INVENTION

A blockchain is a growing list of records (blocks) that are linked to using cryptography. Each block contains a cryptographic hash of the previous block, a timestamp and transaction data.

A blockchain is resistant to modification of its data because once record, the data on the block cannot be altered retroactively without altering the subsequent blocks.

Blockchains records are unalterable, but blockchains may be considered secure by design and exemplify a distributed computing system with high Byzantine fault tolerance.

Blockchains are open distributed ledgers that can record transactions between parties efficiently and in a verifiable and permanent way.

Blocks hold batches of valid transactions that are hashed and encoded into a Merkle Tree. Each block includes the cryptographic hash of the prior block in the blockchain, thus linking the two. The linked blocks form a chain. This iterative process confirms the integrity of the previous block back to the initial block, known as the genesis block.

Sometimes separate blocks can be produced concurrently, creating a temporary fork. in addition to a secure hash-based history, any blockchain has a specified algorithm for scoring different versions of the history so that one with a higher score can be selected over others. Blocks not selected for inclusion in the chain are called orphan blocks.

Peers-supporting the database have different versions of the history from time to time. They keep only the highest-scoring version of the database known to them. Whenever a peer receives a higher-scoring version (usually the old version with a single new block added) they extend or overwrite their own database and retransmit the improvement to their peers.

There is never an absolute guarantee that any particular entry will remain in the best version of the history forever. Blockchains are typically built to add the score of new blocks onto old blocks and are given incentives to extend with new blocks rather than overwrite old blocks, Therefore, the probability of an entry becoming superseded decreases exponentially as more blocks are built on top of it, eventually becoming low.

For example, bitcoin employs a proof-of-work system, where the chain with the most cumulative proof-of-work is considered the valid one by the network. There are a number of methods that can be used to demonstrate a sufficient level of computation. Within a blockchain the computation is carried out redundantly rather than in the traditional segregated and parallel manner.

The block time the average time it takes for the network to generate one extra block in the blockchain. Some blockchains create a new block as frequently as every five seconds. By the time of block completion, the included data becomes verifiable. In cryptocurrency, this is practically when the transaction takes place, so a shorter block time means faster transactions. The block time for Ethereum is set to between 14 and 15 seconds, while for bitcoin it is on average 10 minutes.

A hard fork is a rule change such that the software validating according to the old rules will see the blocks produced according to the new rules as invalid. In case of a hard fork, all nodes meant to work in accordance with the new rules need to upgrade their software.

If one group of nodes continues to use the old software while the other nodes use the new software, a permanent split can occur. For example, Ethereum has hard-force to “make whole” the investors in the DAO, which had been hacked by exploiting a vulnerability in its code. In this case, the fork resulted in a split creating Ethereum and Ethereun Classic chains.

Peer-to-peer blockchain networks lack centralized points of vulnerability that computer crackers can exploit; likewise, it has no central point of failure. Blockchain security methods include the use of public-key cryptography.

A public key (a long, random-looking string of numbers) is an address on the blockchain. Value tokens sent across the network are recorded as belonging to that address. A private key is like a password that gives its owner access to their digital assets or the means to otherwise interact with the various capabilities that blockchains now support. Data stored on the blockchain is generally considered incorruptible.

Every node in a decentralized system has a copy of the blockchain.

Data quality is maintained by massive database replication and computational trust. No centralized “official” copy exists and no user is “trusted” more than any other.

Transactions are broadcast to the network using software. Messages are delivered on a best-effort basis. Mining nodes validate transactions, add them to the block they are building, and then broadcast the completed block to other nodes.

Blockchains use various time-stamping schemes, such as proof-of-work, to serialize changes. Alternative consensus methods include proof-of-stake. Growth of a decentralized blockchain is accompanied by the risk of centralization because the computer resources required to process larger amounts of data become more expensive

Open blockchains are more user-friendly than some traditional ownership records, which, while open to the public, still require physical access to view. Because all early blockchains were permissionless, controversy has arisen over the blockchain definition. An issue in this ongoing debate is whether a private system with verifiers tasked and authorized (permissioned) by a central authority should be considered a blockchain

Proponents of permissioned or private chains argue that the term “blockchain” may be applied to any data structure that batches data into time-stamped blocks. These blockchains serve as a distributed version of multiversion concurrency control (MVCC) in the databases. Just as MVCC prevents two transactions from concurrently modifying a single object in a database, blockchains prevent two transactions from spending the same single output in a blockchain. Opponents say that permissioned systems resemble traditional corporate databases, not supporting decentralized data verification, and that such systems are not hardened against operator tampering and revision.

An advantage to an open, permissionless, or public, blockchain network is that guarding against bad actors is not required and no access control is needed. This means that applications can be added to the network without the approval or trust of others, using the blockchain as a transport layer.

Bitcoin and other cryptocurrencies currently secure their blockchain by requiring new entries to include a proof of work. To prolong the blockchain, bitcoin uses Hashcash puzzles.

Bitcoin and many other cryptocurrencies use open (public) blockchains. As of April 2018, bitcoin has the highest market capitalization.

Permissioned blockchains use an access control layer to govern who has access to the network.

In contrast to public blockchain networks, validators on private blockchain networks are vetted by the network owner. They do not rely on anonymous nodes to validate transactions nor do they benefit from the network effect

Permissioned blockchains can also go by the name of ‘consortium’ blockchains. Permissioned blockchains can guarantee a certain level of decentralization, if carefully designed, as opposed to permissionless blockchains, which are often centralized in practice.

The analysis of public blockchains has become increasingly important with the popularity of bitcoin, Ethereum, litecoin, and other crytocurrencies.

A blockchain, if it is public, provides anyone who wants access to observe and analyse the chain data, given one has the know-how. The process of understanding and accessing the flow of crypto has been an issue for many cryptocurrencies, crypto-exchanges and banks. The reason for this is accusations of blockchain enabled cryptocurrencies enabling illicit dark market trade of drugs, weapons, money laundering etc. A common belief has been that cryptocurrency is private and untraceable, thus leading many actors to use it for illegal purposes. This is changing and now specialised tech-companies provide blockchain tracking services, making crypto exchanges, law-enforcement and banks more aware of what is happening with crypto funds and fiat crypto exchanges.

There are a number of efforts and industry organizations working to employ blockchains in supply chain management. Blockchain technology allows wholesalers, retailers, and customers to track the origins of gemstones and other precious commodities. With gemstones, blockchain-based tracking service can trace the origin of diamonds to insure that they were ethically mined.

The real estate and resource industry is starting to explore the benefits of blocking.

The real-world impact of blockchain is growing quickly with the upswing of production systems bringing new approaches to complex problems. For instance, a supply chain solution powered by blockchain technology is providing critical traceability and geo fencing. However, current blockchain technology is too generalized for either of these resources and is too limited in real estate industry. Likewise, the current blockchain application platform is error-prone, too complicated, and expensive.

The present invention overcomes these problems.

### SUMMARY OF THE INVENTION

A blockchain system for use in the real estate industry comprising
a first step where the transaction is submitted to the peers by an Orderer
a second step where the peers run with the local copy of the ledger
a third step where the read-write set result is returned to all the peers
a fourth step where the endorsement responses are packed into an invocation request
a fifth step where said invocation request is sent to the Order
a sixth step where the read-write set is compared with the same of all the peers
a seventh step where the transaction is added to the ledger
an eighth step where the peers' local copy of the ledger is updated.

### DETAILED DESCRIPTION OF THE PREFERRED EMBODIMENTS

For a more complete understanding of the present invention, the objects and advantages thereof, reference is now made to the ensuing descriptions taken in connection with the accompanying drawings briefly described as follows.

The present invention is an extensive, open development tool set and framework to make developing blockchain applications easier. The present invention accelerates time-to-value, and makes it easier to integrate blockchain applications with the existing business, It utilizes simple inputs and easy to understand instruction, a Plug and Play system that uses proprietary blockchain software deploy a blockchain solution in minutes rather than months and massive expenses.

The present invention is simple to use and geared towards who have very limited technological knowledge.

The contract is transparent, traceable and able to amend quickly, the present invention can input what is the asset to be traded and or real estate contract for either the rental or seller of the property.

When assets need to be traded, the market participants can exchange value for the token or traditional currency and accomplish transactions without a middleman. This has the potential to facilitate more efficient and less costly transactions and it is far more efficient.

The technology is considered for “use registration” due to its capability to manage financial transaction, business transfers etc. This minimizes the risk of manual mistake or errors by creating more secure processes to transfer the ownership of documents.

The use of blockchain to record financial and asset transactions could also be a more effective is examined in real time with less administration time.

When a transaction is submitted, the application alerts all the peers who run it using their local copy of ledger and then sends the result (read-write set) back. All of those endorsement responses are then packed into an invocation request and sent to the Orderer.

If the read-write set of the number of peers according to endorsement policy are identical, then the transaction is added to the ledger and all the peers' local copy of ledger is updated.

The system then secures the contract for completion, rejection and amend.

In a preferred embodiment, the present invention is applicable for the mining and resource industries.

In another preferred embodiment, the present invention is applicable for the real estate industries.

In the present invention, Assets, Participants, and Transactions are recorded in the Wallet, Property, Contract.

In the present invention, the identification, name, description, price, state, estate, seller, and client are recorded under the Contract.

In the present invention, the contract and bool are recorded in the AgreeContract.

In the present invention, the contract is included in the PayRent.

### Real Estate Application

Property portal is developed for users to buy sell rent their properties using this script.

This web application is to be conceived in its current form as a dynamic site requiring constant updates both from the agents as well as the individuals. On the whole the objective of the project is to enable agents and single person to place their property ads. It enables single user to post their properties, manages properties, view properties listings. It will provide various agents to place their properties ads on the site.

Features and Functionalities include Agents, Individuals, Administrator, Property Search, Refine Search, Packages/Plans, Advertisement, and Paypal

Agents/Member—This module contains details about the agent, e.g., name, email, property listing etc. The agent can update, modify and/or delete his/her details and property listing associated with him/her.

The administrator can manage whole website content including CMS, agents/members, property listing, cities, countries, advertisements, site settings and much more.

Property Search—using this module user can search property and then filter is more to find the appropriate property for himself/herself.

The Login is a role based login user where admin have all the authority to view the details. It includes the Admin login, User login, and Agent login

From main website, user can perform following actions: (1) Search and filter property listing with different parameters like property type, location, city, country, price etc; (2) Advance search to filter property listing to get more appropriate listing; (3) Search property by Popular cities list; (4) Register as a individual or as an agent; (5) User can view featured property, featured agents, latest properties list.

After registration users can perform following action: (1) Add/Edit new property ad; (2) Edit/Deactivate posted property; (3) User can manage their profile details; (4) Users can see view details of ad posted and can contact through email; (5) Users can search properties; (6) Users can choose payment plans to before posting ads and property; (7) Users can send message to any property owner

Administrator can manage whole website (1) Manage complete real estate section. Like: add/activate/deactivate/delete/edit property information; (2) Manage agents/members. Like: add/activate/deactivate/delete/edit; (3) Manage whole website content. Fully dynamic CMS is included to manage the content of the website; (4) Manage Payment plans; (5) Manage Favorites; (6) Manage Advertisement including Google adsense; (7) Manage Social Media links; (8) Manage Cities; (9) Manage Countries; (10)Page SEO: Meta Keywords, Meta tags and Meta description for each pagel; (11) Manage project general settings like site name, email, currency, paypal email, address etc.; (12)Admin can manage their Profile setting like update password, address, mobile etc.; (13) Admin can manage their property details.

### Mining Application

The real-world impact of blockchain is growing quickly with the upswing of production systems bringing new approaches to complex problems. One such case: a supply chain solution powered by Hyperledger blockchain technology is providing critical traceability to tantalum mining in Rwanda. This mineral, widely used in the manufacturing of electronics and medical and dental devices and implants, is plentiful and a key to economic development in Rwanda. However, mining practices in nearby regions are muddying the supply chain, making some tantalum a potential “conflict mineral.” To protect against conflict concerns and practices and thus ensure investment and stability in Rwanda-sourced tantalum, the Rwandan Mining, Petroleum and Gas Board turned to a blockchain system to increase transparency in the mining supply chain. Fabric can leverage consensus protocols that do not require a native cryptocurrency to incent costly mining or to fuel smart contract execution. Avoidance of a cryptocurrency reduces some significant risk/attack vectors, and absence of cryptographic mining operations means that the platform can be deployed with roughly the same operational cost as any other distributed system.

Assets include the mineral: This will be mined in the beginning and will be updated in the process with attributes: id, name, kg of raw material, kg of crushing, kg of product, type, state.

The participants will include the miner: With a name, address, using Machine; Crusher: With a name, address, using Machine; Transporter: With a name, address; and, Manufacturer: With a name, address

Transactions include (1) Mine the mineral, (2) Transport it, (3) Crush the mineral, and (4) Manufacture it to a metal

I claim:

1. A blockchain system for use in the real estate industry comprising
a first step where the transaction is submitted to the peers by an Orderer
a second step where the peers run with the local copy of the ledger
a third step where the read-write set result is returned to all the peers
a fourth step where the endorsement responses are packed into an invocation request
a fifth step where said invocation request is sent to the Order
a sixth step where the read-write set is compared with the same of all the peers
a seventh step where the transaction is added to the ledger
an eighth step where the peers' local copy of the ledger is updated.
